(19) United States
(12) Patent Application Publication
(10) Pub. No.: US 2023/0061796 A1
(43) Pub. Date: Mar. 2, 2023

(54) METHOD FOR MANUFACTURING THREE-DIMENSIONAL SHAPED OBJECT AND THREE-DIMENSIONAL SHAPING DEVICE

(71) Applicant: SEIKO EPSON CORPORATION, Tokyo (JP)

(72) Inventor: Shigeru YAMAZAKI, Suwa-shi (JP)

(21) Appl. No.: 17/823,261

(22) Filed: Aug. 30, 2022

(30) Foreign Application Priority Data
Aug. 31, 2021 (JP) 2021-140983

(51) Int. Cl. B29C 64/35; B29C 64/209; B33Y 30/00; B33Y 40/00

(52) U.S. Cl. CPC B29C 64/35; B29C 64/209; B33Y 30/00; B33Y 40/00; B29C 64/153

(57) ABSTRACT

Provided is a method for manufacturing a three-dimensional shaped object. The method for manufacturing the three-dimensional shaped object includes: a first step of receiving designation of a shaping mode of the three-dimensional shaped object; a second step of shaping, based on shaping data for shaping the three-dimensional shaped object, the three-dimensional shaped object by discharging a shaping material from a nozzle; and a third step of controlling cleaning of the nozzle in accordance with the shaping mode received in the first step.

The present application is based on, and claims priority from JP Application Serial Number 2021-140983, filed Aug. 31, 2021, the disclosure of which is hereby incorporated by reference herein in its entirety.

### BACKGROUND

### 1. Technical Field

The present disclosure relates to a method for manufacturing a three-dimensional shaped object and a three-dimensional shaping device.

### 2. Related Art

JP-A-2018-89956 discloses a three-dimensional shaping device that blows air onto a nozzle of a shaping head to remove a foreign matter adhering to the nozzle with a force of the air.

By cleaning the nozzle as described above, a three-dimensional shaped object can be shaped with high precision. However, the precision required for the three-dimensional shaped object varies. When the cleaning of the nozzle is frequently performed at the time of shaping the three-dimensional shaped object for which the precision is not required so much, a shaping time is lengthened, and convenience for a user may be impaired.

### SUMMARY

According to a first aspect of the present disclosure, a method for manufacturing a three-dimensional shaped object is provided. The method for manufacturing the three-dimensional shaped object includes: a first step of receiving designation of a shaping mode of the three-dimensional shaped object; a second step of shaping, based on shaping data for shaping the three-dimensional shaped object, the three-dimensional shaped object by discharging a shaping material from a nozzle; and a third step of controlling cleaning of the nozzle in accordance with the shaping mode received in the first step.

According to a second aspect of the present disclosure, a three-dimensional shaping device is provided. The three-dimensional shaping device includes: a shaping processing unit configured to shape, based on shaping data for shaping a three-dimensional shaped object, the three-dimensional shaped object by discharging a shaping material from a nozzle; and a cleaning control unit configured to control cleaning of the nozzle in accordance with a designated shaping mode.

### BRIEF DESCRIPTION OF THE DRAWINGS

FIG. 1 is an explanatory diagram showing a schematic configuration of a three-dimensional shaping system.

FIG. 2 is a diagram showing a schematic configuration of a discharge unit.

FIG. 3 is a schematic perspective view showing a configuration of a screw.

FIG. 4 is a top view showing a configuration of a barrel.

FIG. 5 is an explanatory diagram showing a schematic configuration of a cleaning mechanism.

FIG. 6 is an explanatory diagram schematically showing a state in which a three-dimensional shaped object is shaped.

FIG. 7 is a flowchart of three-dimensional shaping processing.

FIG. 8 is a diagram showing a correspondence relationship between shaping modes and cleaning processing contents.

FIG. 9 is a flowchart of three-dimensional shaping processing according to a second embodiment.

### DESCRIPTION OF EXEMPLARY EMBODIMENTS

### A. First Embodiment

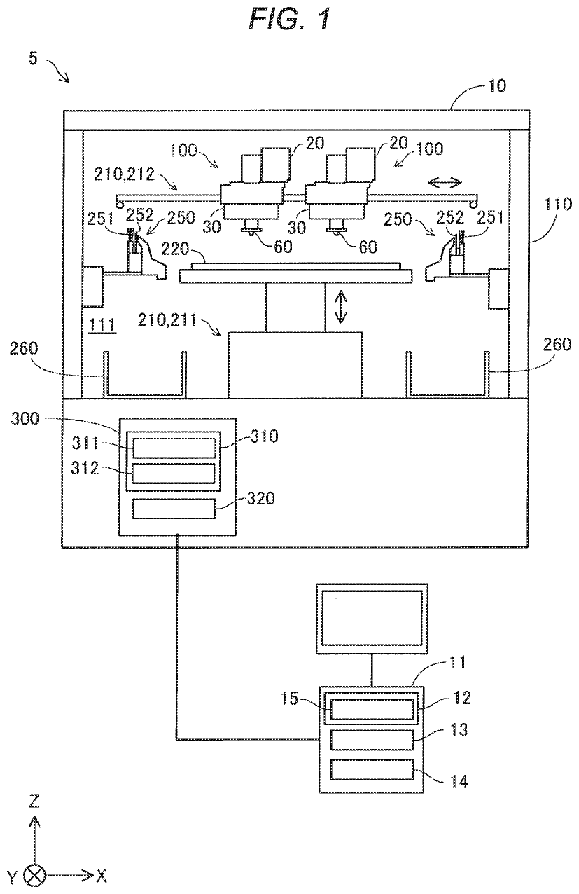

FIG. 1 is an explanatory diagram showing a schematic configuration of a three-dimensional shaping system 5 according to a first embodiment. The three-dimensional shaping system 5 includes a three-dimensional shaping device 10 and an information processing device 11. Arrows along X, Y, and Z directions orthogonal to one another are shown in FIG. 1. The X, Y, and Z directions are directions along an X-axis, a Y-axis, and a-Z axis, which are three spatial axes that are orthogonal to one another, and each of the directions includes a direction on one side along the X-axis, the Y-axis, and the Z-axis, and a direction opposite thereto. The X-axis and the Y-axis are axes along a horizontal plane. The Z-axis is an axis along a vertical line. A −Z direction is a vertical direction. A +Z direction is a direction opposite to the vertical direction. The −Z direction is also referred to as “lower”. The +Z direction is also referred to as “upper”. The X, Y, and Z directions in FIG. 1 and X, Y, and Z directions in other drawings represent the same directions.

The information processing device 11 is a computer including a CPU 12 as a control unit, a memory 13, and a storage device 14. The storage device 14 stores shaping data. The shaping data is data for shaping a three-dimensional shaped object. The shaping data includes movement path information indicating a movement path of a nozzle 60 provided in the three-dimensional shaping device 10 and discharge amount information indicating a discharge amount of a shaping material in the movement path. These pieces of information are described as various commands in the shaping data. The information processing device 11 supplies the shaping data to the three-dimensional shaping device 10. The three-dimensional shaping device 10 shapes a three-dimensional shaped object based on the shaping data supplied from the information processing device 11.

The CPU 12 provided in the information processing device 11 functions as a reception unit 15 by reading a predetermined program from the storage device 14 onto the memory 13 and executing the program. The reception unit 15 receives, via an input device provided in the information processing device 11, designation of a shaping mode from a user. The CPU 12 notifies the three-dimensional shaping device 10 of the designated shaping mode by adding the designated shaping mode to the shaping data.

The three-dimensional shaping device 10 includes discharge units 100, material accommodation units 20, a housing 110, a drive unit 210, a stage 220, cleaning mechanisms 250, and a control unit 300.

The discharge unit 100 includes a plasticization mechanism 30 that plasticizes at least a part of a raw material supplied from the material accommodation unit 20 to generate a shaping material, and the nozzle 60. The discharge unit 100 discharges the shaping material plasticized by the plasticization mechanism 30 from the nozzle 60 toward the stage 220.

The three-dimensional shaping device 10 according to the present embodiment includes two discharge units 100. The shaping material for shaping the three-dimensional shaped object is discharged from the nozzle 60 of one discharge unit 100. A support material for supporting an overhang portion of the three-dimensional shaped object is discharged from the nozzle 60 of the other discharge unit 100. Hereinafter, the former nozzle 60 is also referred to as a main nozzle, and the latter nozzle 60 is also referred to as a support nozzle. The number of the discharge units 100 may be only one, or may be three or more.

The housing 110 has a shaping space 111 therein. The stage 220 on which the shaping material is stacked is disposed in the shaping space 111. The housing 110 may be provided with, for example, an opening that allows the shaping space 111 and the outside to communicate with each other, a door that opens and closes the opening, and the like. The user can take out the shaped object shaped on the stage 220 from the opening by opening the door to make the opening in an open state.

The drive unit 210 changes a relative position between the discharge units 100 and the stage 220. In the present embodiment, the drive unit 210 includes a first drive unit 211 that moves the stage 220 along the Z direction, and a second drive unit 212 that moves the discharge units 100 along the X direction and the Y direction. The first drive unit 211 is implemented as an elevating device, and includes a motor for moving the stage 220 in the Z direction. The second drive unit 212 is implemented as a horizontal conveyance device, and includes a motor for sliding the discharge units 100 along the X direction and a motor for sliding the discharge units 100 along the Y direction. Each motor is driven under control of the control unit 300. In another embodiment, the drive unit 210 may be implemented to move the stage 220 or the discharge units 100 in three directions of X, Y, and Z, or may be implemented to move the stage 220 along the X direction and the Y direction and to move the discharge units 100 in the Z direction.

The cleaning mechanism 250 includes a brush 251 and a blade 252 for cleaning the nozzle 60. The cleaning mechanism 250 is disposed in a region different from the stage 220 in a horizontal direction. The cleaning mechanism 250 is disposed at a height at which the brush 251 and the blade 252 can come into contact with the nozzle 60 in the vertical direction. A purge waste material container 260 is provided below each of the cleaning mechanisms 250. A resin dust removed by the cleaning mechanism 250 falls and is collected in the purge waste material container 260. The blade 252 is also referred to as a flicker plate. The cleaning mechanism 250 is also referred to as a tip wipe assembly. Although FIG. 1 shows an example in which the cleaning mechanism 250 and the purge waste material container 260 are provided for each of the two discharge units 100, the cleaning mechanism 250 and the purge waste material container 260 may be provided in common for the two discharge units 100.

The control unit 300 is implemented by a computer including a CPU 310 and a memory 320. The CPU 310 provided in the control unit 300 functions as a shaping processing unit 311 and a cleaning control unit 312 by executing a predetermined program on the memory 320. The shaping processing unit 311 controls the discharge unit 100 and the drive unit 210 based on the shaping data supplied from the information processing device 11 to cause the nozzle 60 to discharge the shaping material to shape the three-dimensional shaped object. The cleaning control unit 312 controls cleaning of the nozzle 60 using the cleaning mechanism 250 in accordance with the shaping mode added to the shaping data. The control unit 300 may be implemented by a combination of a plurality of circuits instead of the computer.

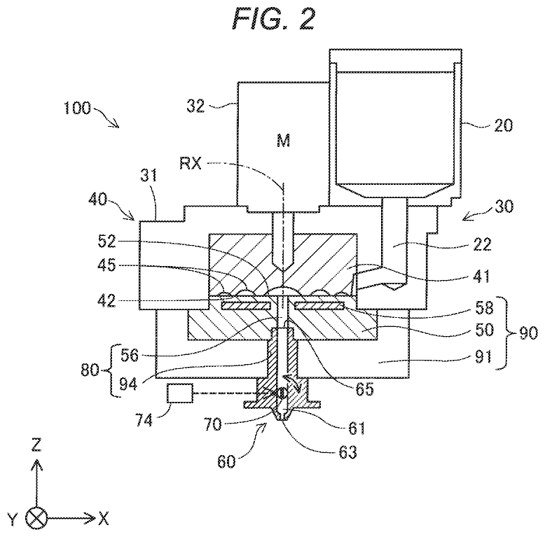

FIG. 2 is a diagram showing a schematic configuration of the discharge unit 100. The discharge unit 100 includes the plasticization mechanism 30, the nozzle 60, and a flow rate adjustment unit 70. The plasticization mechanism 30 includes a material conveying mechanism 40 and a heating block 90. A material accommodated in the material accommodation unit 20 is supplied to the discharge unit 100. Under the control of the control unit 300, the discharge unit 100 plasticizes at least a part of the material supplied from the material accommodation unit 20 by the plasticization mechanism 30 to generate a shaping material, and ejects the generated shaping material from the nozzle 60 onto the stage 220 to stack the shaping material. In the present embodiment, the term “plasticization” is a concept including melting, and refers to changing from a solid state to a flowable state. Specifically, in a case of a material in which glass transition occurs, the plasticization refers to setting a temperature of the material to be equal to or higher than a glass transition point. In a case of a material in which the glass transition does not occur, the plasticization refers to setting the temperature of the material to be equal to or higher than a melting point.

In the material accommodation unit 20 according to the present embodiment, a material in a state of pellets, powder, or the like is accommodated. In the present embodiment, the material accommodated in the material accommodation unit 20 is a pellet-shaped ABS resin. The material accommodation unit 20 according to the present embodiment is implemented by a hopper. The material accommodated in the material accommodation unit 20 is supplied to the material conveying mechanism 40 of the plasticization mechanism 30 through a supply path 22 provided below the material accommodation unit 20 so as to couple the material accommodation unit 20 and the discharge unit 100.

The heating block 90 has a heater 58. The heater 58 is controlled by the control unit 300, and is heated to a plasticization temperature for plasticizing the material. The plasticization temperature varies in accordance with a type of the material to be used, and is, for example, the glass transition point or the melting point of the material. When the material is the ABS resin, the plasticization temperature is set to, for example, about 110° C., which is the glass transition point of the ABS resin. The heating block 90 is provided with a through hole 80. The through hole 80 is implemented such that the nozzle 60 can be attached to and detached from the through hole 80. The material conveying mechanism 40 conveys the shaping material toward a nozzle flow path 61 of the nozzle 60 attached to the through hole 80 of the heating block 90. The plasticization mechanism 30 conveys the material supplied from the material accommodation unit 20 to the material conveying mechanism 40 toward the nozzle flow path 61 of the nozzle 60 by the material conveying mechanism 40, and heats and plasticizes the material by the heat of the heating block 90.

The material conveying mechanism 40 according to the present embodiment includes a screw case 31, a screw 41 accommodated in the screw case 31, and a drive motor 32 that drives the screw 41. The heating block 90 according to the present embodiment includes a case portion 91 having an opening 94, and a barrel 50 disposed in the case portion 91. The barrel 50 is provided with a communication hole 56. The through hole 80 according to the present embodiment is formed by the opening 94 and the communication hole 56 communicating with each other. The above-described heater 58 is incorporated in the barrel 50. The screw 41 according to the present embodiment is a so-called flat screw, and may be referred to as “scroll”.

The screw 41 has a substantially cylindrical shape in which a height in a direction along a central axis RX of the screw 41 is smaller than a diameter. The screw 41 has a groove forming surface 42 in which screw grooves 45 are formed on a surface facing the barrel 50. The groove forming surface 42 faces a screw facing surface 52 of the barrel 50 to be described later. The central axis RX according to the present embodiment coincides with a rotation axis of the screw 41. Details of a configuration of the screw 41 will be described later.

The drive motor 32 is coupled to a surface of the screw 41 opposite to the groove forming surface 42. The drive motor 32 is driven under the control of the control unit 300. The screw 41 is rotated about the central axis RX by a torque generated by rotation of the drive motor 32. The drive motor 32 may not be directly coupled to the screw 41, and may be coupled via, for example, a speed reducer.

The barrel 50 has the screw facing surface 52 facing the groove forming surface 42 of the screw 41. The case portion 91 is disposed so as to cover a surface of the barrel 50 opposite to the screw facing surface 52, that is, a lower surface of the barrel 50. The above-described communication hole 56 and the opening 94 are provided at positions overlapping the central axis RX of the screw 41. That is, the through hole 80 is located at a position overlapping the central axis RX.

As described above, the nozzle 60 is detachably attached to the through hole 80 of the heating block 90. The nozzle 60 is also referred to as a nozzle tip. The nozzle 60 is provided with the above-described nozzle flow path 61. The nozzle flow path 61 has a nozzle opening 63 at a front end of the nozzle 60, and has an inflow port 65 at a rear end of the nozzle 60. The nozzle opening 63 is located at a position in the -Z direction of the inflow port 65. The nozzle 60 according to the present embodiment discharges the material, which flows into the nozzle flow path 61 through the communication hole 56 and the inflow port 65, from the nozzle opening 63 toward the stage 220.

The flow rate adjustment unit 70 changes an opening degree of the nozzle flow path 61 by rotating in the nozzle flow path 61. In the present embodiment, the flow rate adjustment unit 70 includes a butterfly valve. The flow rate adjustment unit 70 is driven by a valve drive unit 74 under the control of the control unit 300. The valve drive unit 74 includes, for example, a stepping motor. The control unit 300 can adjust a flow rate of the shaping material flowing from the material conveying mechanism 40 to the nozzle 60, that is, a flow rate of the shaping material discharged from the nozzle 60, by controlling a rotation angle of the butterfly valve using the valve drive unit 74. The flow rate adjustment unit 70 adjusts the flow rate of the shaping material and controls ON or OFF of an outflow of the shaping material.

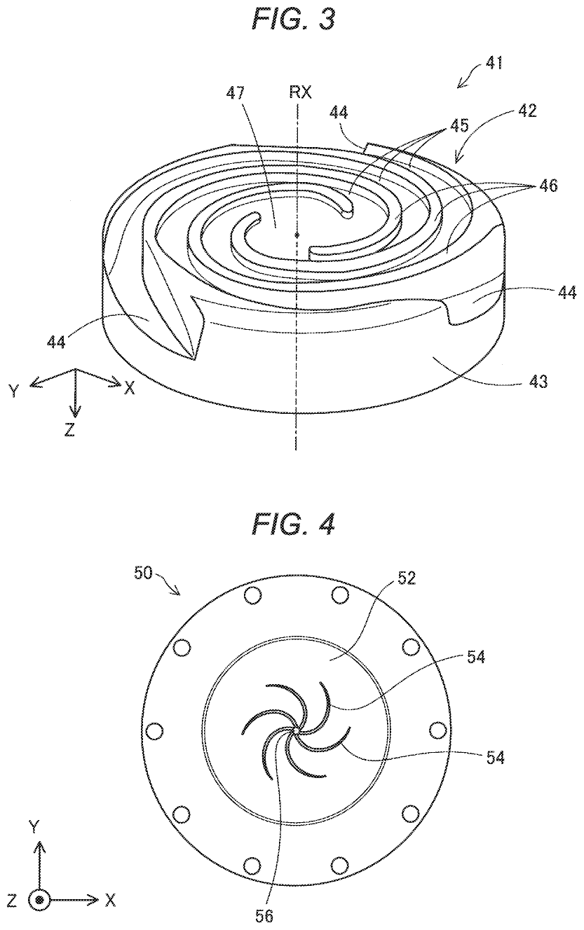

FIG. 3 is a schematic perspective view showing the configuration of the screw 41 on a groove forming surface 42 side. In FIG. 3, a position of the central axis RX of the screw 41 is indicated by a one-dot chain line. As described above, the screw grooves 45 are provided in the groove forming surface 42. A screw central portion 47, which is a central portion of the groove forming surface 42 of the screw 41, is implemented as a recess to which one end of the screw groove 45 is coupled. The screw central portion 47 faces the communication hole 56 of the barrel 50. The screw central portion 47 intersects the central axis RX.

The screw grooves 45 of the screw 41 implement a so-called scroll groove. The screw grooves 45 extend in a spiral shape from the screw central portion 47 toward an outer periphery of the screw 41 in a manner of drawing arcs. The screw groove 45 may be implemented to extend in an involute curve shape or a spiral shape. The groove forming surface 42 is provided with ridge portions 46 that implement side wall portions of the screw grooves 45 and extend along each of the screw grooves 45. The screw grooves 45 are continuous to material introduction ports 44 formed in a side surface 43 of the screw 41. The material introduction port 44 is a portion that receives the material supplied through the supply path 22 of the material accommodation unit 20.

FIG. 3 shows an example of the screw 41 having three screw grooves 45 and three ridge portions 46. The number of the screw grooves 45 and the ridge portions 46 provided in the screw 41 is not limited to three, and only one screw groove 45 may be provided, or two or more (a plurality of) screw grooves 45 may be provided. FIG. 3 shows an example of the screw 41 in which the material introduction ports 44 are formed at three positions. The number of positions of the material introduction ports 44 provided in the screw 41 is not limited to three. The material introduction ports 44 may be provided only at one position or may be provided at two or more (a plurality of) positions.

FIG. 4 is a top view showing a configuration of the barrel 50 on a screw facing surface 52 side. As described above, the communication hole 56 is formed in the center of the screw facing surface 52. A plurality of guide grooves 54 are formed around the communication hole 56 in the screw facing surface 52. Each of the guide grooves 54 has one end coupled to the communication hole 56 and extends in a spiral shape from the communication hole 56 toward an outer periphery of the screw facing surface 52. Each of the guide grooves 54 has a function of guiding the shaping material to the communication hole 56. One end of the guide groove 54 may not be coupled to the communication hole 56. The guide groove 54 may not be formed in the barrel 50.

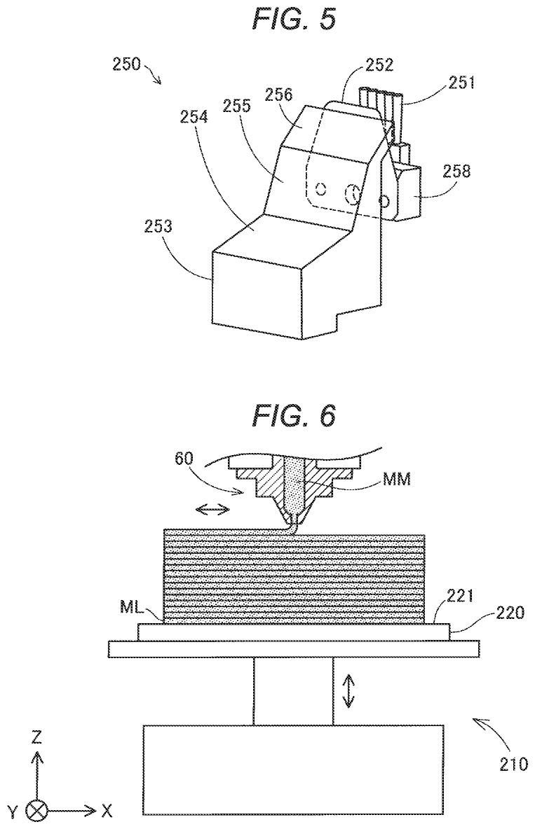

FIG. 5 is an explanatory diagram showing a schematic configuration of the cleaning mechanism 250. As described above, the cleaning mechanism 250 includes the brush 251 and the blade 252. The brush 251 is implemented by arranging a plurality of bristle bundles along the Y direction. The blade 252 is a plate-shaped member along the Z direction and the Y direction. A front end of the brush 251 and a front end of the blade 252 face the +Z direction. The front end of the blade 252 is disposed below the front end of the brush 251. As described above, the brush 251 and the blade 252 are disposed at a height at which the brush 251 and the blade 252 can come into contact with the nozzle 60. In the present embodiment, the brush 251 and the blade 252 are integrated by a fixture 258, and can be replaced at the same time when the brush 251 and the blade 252 are consumed. The brush 251 and the blade 252 may be individually replaceable.

The cleaning mechanism 250 further includes a purge unit 253. The purge unit 253 is also referred to as a purge ledge. In the present embodiment, the purge unit 253, the blade 252, and the brush 251 are arranged in this order in the horizontal direction. That is, the blade 252 is disposed between the purge unit 253 and the brush 251. A front end of the purge unit 253 in the +Z direction is lower than the front end of the blade 252. On the purge unit 253, the shaping material as a waste material ejected from the nozzle 60 falls, is collected into a spherical shape on the purge unit 253, and falls into the purge waste material container 260. An upper surface of the purge unit 253 is implemented as an inclined surface in order to promote the falling of the waste material. More specifically, the purge unit 253 includes a first inclined surface 254, a second inclined surface 255, and a third inclined surface 256 in ascending order of distance from the blade 252 and in ascending order of position in the vertical direction. In the present embodiment, inclination angles of the second inclined surface 255 and the third inclined surface 256 with respect to the horizontal plane are larger than an inclination angle of the first inclined surface 254 with respect to the horizontal plane.

Although the cleaning mechanism 250 in the present embodiment includes the brush 251, the blade 252, and the purge unit 253, for example, the purge unit 253 may be omitted. For example, the cleaning mechanism 250 may include only the brush 251 or only the blade 252.

FIG. 6 is an explanatory diagram schematically showing a state in which a three-dimensional shaped object is shaped in the three-dimensional shaping device 10. In the three-dimensional shaping device 10, as described above, in the discharge unit 100, a solid raw material supplied to the screw groove 45 of the rotating screw 41 is melted to generate a shaping material MM. The control unit 300 causes the nozzle 60 to discharge the shaping material MM while changing a position of the nozzle 60 with respect to the stage 220 in a direction along a shaping surface 221 of the stage 220 by controlling the drive unit 210 with a distance maintained constant between the shaping surface 221 on the stage 220 and the nozzle 60. The shaping material MM discharged from the nozzle 60 is continuously deposited in a moving direction of the nozzle 60, and a layer ML is formed. After forming one layer ML, the control unit 300 lowers the stage 220 to move the position of the nozzle 60 relative to the stage 220 in the +Z direction. Then, the three-dimensional shaped object is shaped by further stacking the layer ML on the layer ML formed so far.

For example, the control unit 300 may temporarily interrupt the discharge of the shaping material from the nozzle 60 when the nozzle 60 moves in the Z direction after one layer ML is completely formed or when there are a plurality of independent shaping regions in each layer. In this case, the control unit 300 closes the nozzle flow path 61 by the flow rate adjustment unit 70 and stops the discharge of the shaping material MM from the nozzle opening 63. After changing the position of the nozzle 60, the control unit 300 causes the flow rate adjustment unit 70 to open the nozzle flow path 61, thereby resuming the deposition of the shaping material MM from the changed position of the nozzle 60.

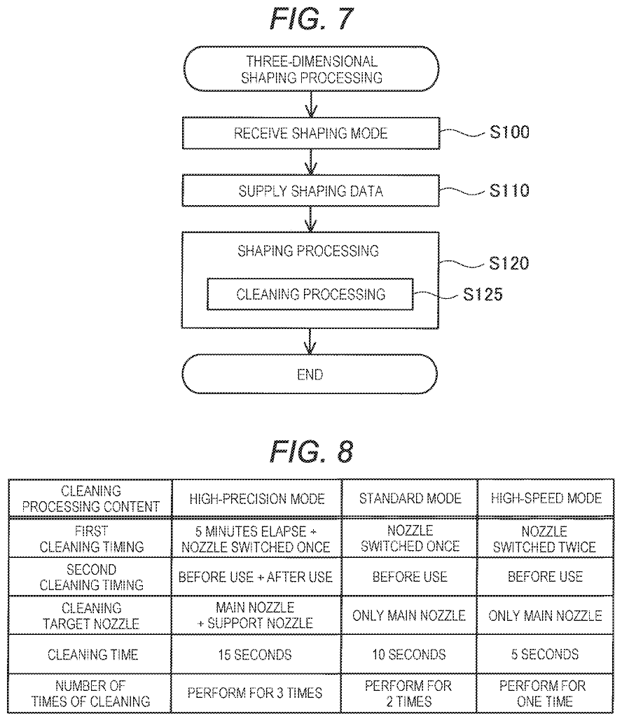

FIG. 7 is a flowchart of three-dimensional shaping processing representing a method for manufacturing a three-dimensional shaped object. In step S100, the reception unit 15 of the information processing device 11 receives designation of the shaping mode. This step S100 is also referred to as a first step. For example, the information processing device 11 displays a plurality of shaping modes on a display device coupled to the information processing device 11. The user selects and designates a desired shaping mode from the plurality of shaping modes using an input device such as a mouse.

In step S110, the information processing device 11 adds the designated shaping mode to the shaping data stored in the storage device 14, and supplies the shaping data to the three-dimensional shaping device 10. To add the shaping mode specifically means to add an identifier representing the shaping mode to the shaping data.

In step S120, the shaping processing unit 311 of the three-dimensional shaping device 10 executes shaping processing. In the shaping processing, the shaping processing unit 311 shapes, in accordance with the shaping data supplied from the information processing device 11, the three-dimensional shaped object by discharging the shaping material from the nozzle 60 while moving the nozzle 60 and stacking a plurality of layers. The step S120 is also referred to as a second step.

During the shaping processing of step S120, the cleaning control unit 312 executes cleaning processing as step S125 in accordance with the shaping mode represented by the identifier added to the shaping data. This step S125 is also referred to as a third step. In step S125, the cleaning control unit 312 performs cleaning of the nozzle based on a cleaning processing content associated with the shaping mode in advance.

FIG. 8 is a diagram showing a correspondence relationship between shaping modes and cleaning processing contents. In the present embodiment, the user can select the shaping mode from a plurality of modes including a mode related to shaping precision of the three-dimensional shaped object and a mode related to a shaping time of the three-dimensional shaped object. In FIG. 8, three modes of a high-precision mode, a standard mode, and a high-speed mode are listed. The high-precision mode is a mode related to the shaping precision. The high-speed mode is a mode related to the shaping time. The high-precision mode is a mode for shaping the three-dimensional shaped object with higher precision as compared with the high-speed mode and the standard mode. The high-speed mode is a mode for shaping the three-dimensional shaped object at a higher speed as compared with the high-precision mode and the standard mode. In step S100, the user selects and designates a desired mode from the three modes.

As the cleaning processing content in each mode, a first cleaning timing, a second cleaning timing, a cleaning target nozzle, a cleaning time, and the number of times of cleaning are determined.

When the high-precision mode is designated as the shaping mode, the cleaning control unit 312 performs the cleaning processing every time the shaping time elapses for five minutes and every time the nozzle 60 to be used is switched once as the first cleaning timing. At the time of switching the nozzle 60, the cleaning processing is performed both before and after the use of the nozzle 60 as the second cleaning timing. The cleaning target nozzles are the nozzles 60 including both the main nozzle and the support nozzle. Further, the cleaning time is set to 15 seconds, and the number of times of cleaning is set to 3. The cleaning time refers to a time spent on a series of cleaning steps in the cleaning processing. The number of times of cleaning refers to the number of times of performing the series of cleaning steps. The series of cleaning steps is, for example, a step in which, after a predetermined amount of the shaping material is discharged from the nozzle 60 on the purge unit 253, the front end of the nozzle 60 passes over the blade 252 so as to come into contact with the blade 252, and the front end of the nozzle 60 is caused to reciprocate a predetermined number of times over the brush 251 while coming into contact with the brush 251. In the present embodiment, lengthening the cleaning time is implemented by lengthening a time for discharging the shaping material from the nozzle 60 in the series of steps. In the present embodiment, the number of times of cleaning represents a strength of cleaning. That is, as the number of times of cleaning increases, cleaning with a higher strength is performed. The strength of the cleaning may be represented by, for example, the number of rotations of the screw or discharge pressure when the shaping material is discharged on the purge unit 253.

When the standard mode is designated as the shaping mode, the cleaning control unit 312 performs the cleaning processing every time the nozzle 60 to be used is switched once as the first cleaning timing, and performs the cleaning processing only before the use of the nozzle 60, as the second cleaning timing, at the time of switching the nozzle 60. Further, the cleaning target nozzle is only the main nozzle, the cleaning time is set to 10 seconds, and the number of times of cleaning is set to 2.

When the high-speed mode is designated as the shaping mode, the cleaning control unit 312 performs the cleaning processing every time the nozzle 60 to be used is switched twice as the first cleaning timing, and performs the cleaning processing only before the use of the nozzle 60, as the second cleaning timing, at the time of switching the nozzle 60. Then, the cleaning target nozzle is only the main nozzle. Further, the cleaning time is set to 5 seconds and the number of times of cleaning is set to 1.

As described above, in the high-precision mode, as compared with the standard mode and the high-speed mode, the number of times the cleaning processing is performed in one three-dimensional shaping processing is increased. Therefore, the three-dimensional shaped object can be shaped with high precision. In the high-speed mode, as compared with the standard mode and the high-precision mode, the number of times the cleaning processing is performed in one three-dimensional shaping processing is reduced. Therefore, the three-dimensional shaped object can be shaped at high speed.

Prior to above-described step S110, the information processing device 11 may execute shaping data generation processing for generating the shaping data. In the shaping data generation processing, the information processing device 11 acquires shape data such as three-dimensional CAD data representing a shape of the three-dimensional shaped object, analyzes the shape data, and slices the shape of the three-dimensional shaped object into a plurality of layers along an XY plane. Then, the information processing device 11 generates movement path information representing a movement path of the nozzle 60 for filling an outer shell and an inner region of each layer. The movement path information includes data indicating a plurality of linear movement paths. Each movement path included in the movement path information includes the discharge amount information indicating the discharge amount of the shaping material discharged in the corresponding movement path. The information processing device 11 generates the shaping data by generating the movement path information and the discharge amount information for all the layers. The shaping data is represented by, for example, a G code.

According to the first embodiment described above, the cleaning of the nozzle 60 is controlled in accordance with the shaping mode selected by the user. Therefore, for example, a situation in which the cleaning is frequently performed at the time of shaping a three-dimensional shaped object for which precision is not required does not occur. Therefore, it is possible to improve convenience for the user without unintentionally lengthening the shaping time.

In the present embodiment, when the high-precision mode is selected as the shaping mode, as compared with a case where the standard mode is selected as the shaping mode, at least one of the number of times of cleaning, the cleaning time, a cleaning strength, and the cleaning target nozzle is made different in the cleaning step. Specifically, when the high-precision mode is selected, as compared with the case where the standard mode is selected as the shaping mode, at least one of (A) increasing the number of times of cleaning, (B) lengthening the cleaning time, (C) increasing the cleaning strength, and (D) increasing the number of cleaning target nozzles is performed. Therefore, in the high-precision mode, cleanliness of the nozzle 60 can be increased, and the three-dimensional shaped object can be shaped with high precision.

In the present embodiment, lengthening the cleaning time is implemented by lengthening the time for discharging the shaping material from the nozzle 60. Therefore, it is possible to easily lengthen the cleaning time. In another embodiment, the cleaning time may be increased by increasing the number of times the nozzle 60 is reciprocated on the brush 251, that is, the number of times the nozzle 60 is brushed. In this manner, it is possible to easily lengthen the cleaning time.

In the present embodiment, the cleaning processing content in each mode is determined by five items of the first cleaning timing, the second cleaning timing, the cleaning target nozzle, the cleaning time, and the number of times of cleaning, as shown in FIG. 8. In contrast, all of the items may not be defined, and at least one of the items may be defined in each mode.

In the present embodiment, in the standard mode, only the main nozzle is used as the cleaning target nozzle, whereas both the main nozzle and the support nozzle may be used as the cleaning target nozzle in the standard mode. In this case, when the high-speed mode is selected as the shaping mode, as compared with the case where the standard mode is selected as the shaping mode, the number of times of cleaning of the support nozzle in the cleaning step is reduced. Shaping precision depending on the support material has a small influence on the precision of the three-dimensional shaped object. Therefore, by reducing the number of times of cleaning of the support nozzle, it is possible to perform high-speed shaping while preventing the influence on the shaping precision of the three-dimensional shaped object.

In the present embodiment, in the high-precision mode, the number of times of the cleaning processing is increased than in other modes, and the shaping time is lengthened. Therefore, the high-precision mode can also be referred to as a low-speed mode. In the high-speed mode, the number of times of the cleaning processing is reduced than in other modes, and the shaping precision is lower. Therefore, the high-speed mode can also be referred to as a low-precision mode.

### B. Second Embodiment

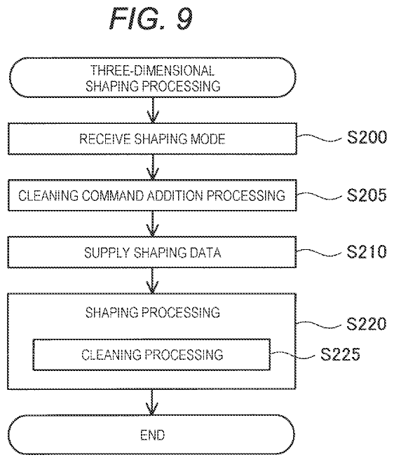

FIG. 9 is a flowchart of three-dimensional shaping processing according to a second embodiment. The three-dimensional shaping processing according to the first embodiment and the three-dimensional shaping processing according to the second embodiment are different from each other in that a cleaning command is added to shaping data after reception of a shaping mode.

Similarly to step S100 in the first embodiment, in step S200 in the second embodiment, the reception unit 15 of the information processing device 11 receives designation of the shaping mode.

In the second embodiment, in subsequent step S205, the CPU 12 of the information processing device 11 executes cleaning command addition processing. The cleaning command addition processing is processing of adding, to the shaping data, a cleaning command corresponding to the shaping mode received in step S200. Specifically, in the cleaning command addition processing, the CPU 12 adds a command for implementing a cleaning processing content shown in FIG. 8 to the shaping data in accordance with the shaping mode received in step S200. For example, when the high-precision mode is designated, a cleaning command is added to the shaping data so that the nozzle 60 is cleaned when every five minutes elapse. Further, a cleaning command is added before and after each nozzle switching command so that cleaning is executed before and after each nozzle 60 is switched. In this manner, when the cleaning command is added, for example, when the high-precision mode or the low-speed mode is designated as the shaping mode, as compared with a case where the standard mode is designated as the shaping mode, the number of cleaning commands added to the shaping data is increased or a cleaning command having a stronger strength than that of a cleaning command added to the shaping data in the standard mode is added.

In step S210, the information processing device 11 supplies the shaping data to which the cleaning command is added to the three-dimensional shaping device 10.

In step S220, the shaping processing unit 311 of the three-dimensional shaping device 10 executes shaping processing. In the shaping processing, a three-dimensional shaped object is shaped in accordance with the shaping data. While the three-dimensional shaped object is shaped, the cleaning control unit 312 interprets the cleaning command added to the shaping data, and controls the cleaning processing in step S225 in accordance with an operation indicated by the cleaning command.

According to the second embodiment described above, the information processing device 11 adds the cleaning command corresponding to the shaping mode to the shaping data, and thus the three-dimensional shaping device 10 can perform cleaning corresponding to the shaping mode only by operating the nozzle 60 in accordance with the cleaning command. Therefore, a load of the cleaning processing in the three-dimensional shaping device 10 is reduced.

In the above-described second embodiment, the CPU 12 of the information processing device 11 executes processing of adding the cleaning command corresponding to the shaping mode to the shaping data. In contrast, the shaping data including the cleaning command corresponding to the shaping mode may be generated in accordance with the shaping mode designated by the user. It is not necessary to add the cleaning command corresponding to the shaping mode later, and the shaping data including the cleaning command corresponding to the shaping mode can be quickly generated.

### C. Other Embodiments

(C1) In the above-described first embodiment, the information processing device 11 receives designation of a shaping mode. In contrast, the designation of the shaping mode may be received by the three-dimensional shaping device 10 through a predetermined operation button provided in the three-dimensional shaping device 10. In this case, in step S100 shown in FIG. 7, instead of the information processing device 11, the three-dimensional shaping device 10 receives the designation of the shaping mode, and in step S110, the shaping mode is not added to the shaping data. In this manner, as in the first embodiment, convenience for the user can be improved.

(C2) In the above-described embodiments, the CPU 12 of the information processing device 11 may generate the shaping data in accordance with the shaping mode designated by the user. For example, when the high-precision mode is designated, as compared with the standard mode, the CPU 12 reduces a stack pitch or reduces a line width of the discharged shaping material. In this manner, not only cleaning processing contents but also the stack pitch and the line width can be changed in accordance with the shaping mode, so that the convenience for the user can be further improved.

(C3) In the above-described embodiments, the plasticization mechanism 30 includes the flat screw as the screw 41. On the other hand, the plasticization mechanism 30 may include an in-line screw. The discharge unit 100 may be capable of discharging the shaping material while moving the nozzle 60 relative to the stage 220. For example, various types of discharge units such as an FDM type, a binder jet type, and an inkjet type may be adopted.

(C4) In the above embodiments, the pellet-shaped ABS resin is used as the raw material of the shaping material. In contrast, the three-dimensional shaping device 10 can shape a three-dimensional shaped object using various materials such as a thermoplastic material, a metal material, and a ceramic material as main materials. Here, the “main material” indicates a material serving as a center forming the shape of the three-dimensional shaped object, and indicates a material having a content of 50 wt % or more in the three-dimensional shaped object. The above-described shaping material includes a material obtained by melting the main material alone or a material obtained by melting a part of components contained together with the main material to form a paste.

When the thermoplastic material is used as the main material, the shaping material is generated by plasticizing the material in the plasticization mechanism 30. For example, the following thermoplastic resin materials can be used as the thermoplastic material.

### Examples of Thermoplastic Resin Material

General engineering plastics such as polypropylene resin (PP), polyethylene resin (PE), polyacetal resin (POM), polyvinyl chloride resin (PVC), polyamide resin (PA), acrylonitrile-butadiene-styrene resin (ABS), polylactic acid resin (PLA), polyphenylene sulfide resin (PPS), polyether ether ketone (PEEK), polycarbonate (PC), modified polyphenylene ether, polybutylene terephthalate, and polyethylene terephthalate; and engineering plastics such as polysulfone, polyethersulfone, polyphenylene sulfide, polyarylate, polyimide, polyamideimide, polyetherimide, and polyether ether ketone

The thermoplastic material may contain a pigment, a metal, a ceramic, and other additives such as wax, a flame retardant, an antioxidant, and a heat stabilizer. In the plasticization mechanism 30, the thermoplastic material is plasticized and converted into a molten state by the rotation of the screw 41 and the heating of the heater 58. The shaping material generated by melting the thermoplastic material is discharged from the nozzle 60 and then cured by a decrease in temperature.

It is desirable that the thermoplastic material is ejected from the nozzle 60 in a state of being heated to a temperature equal to or higher than a glass transition point thereof and completely melted. For example, a glass transition point of the ABS resin is about 110° C., and it is desirable that the ABS resin is ejected from the nozzle 60 at about 200° C.

In the three-dimensional shaping device 10, for example, the following metal materials may be used as the main material instead of the above-described thermoplastic material. In this case, it is desirable that a component to be melted at the time of generation of the shaping material is mixed with a powder material obtained by powdering the following metal material, and a mixture is charged into the plasticization mechanism 30 as the raw material.

### Examples of Metal Material

Single metal such as magnesium (Mg), ferrum (Fe), cobalt (Co), chromium (Cr), aluminum (Al), titanium (Ti), copper (Cu), and nickel (Ni), or an alloy containing one or more of these metals

### Examples of Alloy

Maraging steel, stainless steel, cobalt chromium molybdenum, titanium alloy, nickel alloy, aluminum alloy, cobalt alloy, and cobalt chromium alloy

In the three-dimensional shaping device 10, a ceramic material can be used as the main material instead of the above-described metal material. Examples of the ceramic material include oxide ceramics such as silicon dioxide, titanium dioxide, aluminum oxide, and zirconium oxide, and non-oxide ceramics such as aluminum nitride. When the above-described metal material or the ceramic material is used as the main material, the shaping material disposed on the stage 220 may be cured by laser irradiation or sintering by warm air or the like.

A powder material of the metal material or the ceramic material to be charged into the material accommodation unit 20 as the raw material may be a mixed material obtained by mixing a plurality of kinds of powder of a single metal, powder of an alloy, and powder of a ceramic material. The powder material of the metal material or the ceramic material may be coated with, for example, a thermoplastic resin as exemplified above or another thermoplastic resin. In this case, the thermoplastic resin may be melted to exhibit fluidity in the plasticization mechanism 30.

For example, the following solvents can be added to the powder material of the metal material or the ceramic material that is charged into the material accommodation unit 20 as the raw material. The solvent can be used alone or in combination of two or more selected from the following.

### Examples of Solvent

Water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetate (for example, tetrabutylammonium acetate); and ionic liquids such as butyl carbitol acetate

In addition, for example, the following binders may be added to the powder material of the metal material or the ceramic material which is charged into the material accommodation unit 20 as the raw material.

### Examples of Binder

An acrylic resin, an epoxy resin, a silicone resin, a cellulose-based resin, or other synthetic resin, or a polylactic acid (PLA), polyamide (PA), polyphenylene sulfide (PPS), polyether ether ketone (PEEK), or other thermoplastic resins

### D. Other Aspects

The present disclosure is not limited to the embodiments described above, and can be implemented in various forms without departing from the scope of the present disclosure. For example, technical features of the embodiments corresponding to technical features of the embodiments described below can be appropriately replaced or combined in order to solve a part or all of the above problems or to achieve a part or all of the above effects. Any of the technical features may be omitted as appropriate unless the technical feature is described as essential herein.

(1) According to a first aspect of the present disclosure, a method for manufacturing a three-dimensional shaped object is provided. The method for manufacturing the three-dimensional shaped object includes: a first step of receiving designation of a shaping mode of the three-dimensional shaped object; a second step of shaping, based on shaping data for shaping the three-dimensional shaped object, the three-dimensional shaped object by discharging a shaping material from a nozzle; and a third step of controlling cleaning of the nozzle in accordance with the shaping mode received in the first step.

According to such an aspect, since the cleaning of the nozzle is controlled in accordance with the shaping mode selected by a user, it is possible to improve convenience for the user.

(2) In the above aspect, in the first step, the shaping mode may be designated from a plurality of modes including a mode related to shaping precision of the three-dimensional shaped object and a mode related to a shaping time of the three-dimensional shaped object. According to such an aspect, the shaping mode corresponding to the shaping precision and the shaping time can be selected.

(3) In the above aspect, when a high-precision mode in which the three-dimensional shaped object is shaped with high precision or a low-speed mode in which the three-dimensional shaped object is shaped at a low speed is designated as the shaping mode, as compared with a case where a standard mode is designated as the shaping mode, at least one of the number of times of cleaning, a cleaning time, a cleaning strength, and a cleaning target nozzle may be made different in the third step.

(4) In the above aspect, when the high-precision mode or the low-speed mode is designated as the shaping mode, as compared with the case where the standard mode is designated as the shaping mode, at least one of (A) increasing the number of times of cleaning, (B) lengthening the cleaning time, (C) increasing the cleaning strength, and (D) increasing the number of cleaning target nozzles may be performed. According to such an aspect, it is possible to increase cleanliness of the nozzle in the high-precision mode or the low-speed mode.

(5) In the above aspect, the (B) lengthening the cleaning time may be implemented by lengthening a time for discharging the shaping material from the nozzle or increasing the number of times of brushing the nozzle. According to such an aspect, the cleaning time can be easily lengthened.

(6) In the above aspect, when a low-precision mode in which the three-dimensional shaped object is shaped with low precision or a high-speed mode in which the three-dimensional shaped object is shaped at a high speed is designated as the shaping mode, as compared with a case where a standard mode is designated as the shaping mode, the number of times of cleaning of the nozzle that discharges a support material in the third step may be reduced. Shaping precision depending on the support material has a small influence on the precision of the three-dimensional shaped object. Therefore, high-speed shaping can be performed by reducing the number of times of cleaning the nozzle that discharges the support material.

(7) In the above aspect, a cleaning command may be added to the shaping data in accordance with the shaping mode received in the first step, and in the third step, cleaning may be controlled in accordance with the cleaning command in the shaping data.

(8) In the above aspect, when a high-precision mode in which the three-dimensional shaped object is shaped with high precision or a low-speed mode in which the three-dimensional shaped object is shaped at a low speed is designated as the shaping mode, as compared with a case where a standard mode is designated as the shaping mode, the number of cleaning commands added to the shaping data may be increased or a cleaning command having a stronger strength than that of a cleaning command added in the standard mode may be added to the shaping data.

(9) According to a second aspect of the present disclosure, a three-dimensional shaping device is provided. The three-dimensional shaping device includes: a shaping processing unit configured to shape, based on shaping data for shaping a three-dimensional shaped object, the three-dimensional shaped object by discharging a shaping material from a nozzle; and a cleaning control unit configured to control cleaning of the nozzle in accordance with a designated shaping mode.

(10) According to a third embodiment of the present disclosure, an information processing device is provided. The information processing device includes a reception unit that receives designation of a shaping mode of a three-dimensional shaped object, and a control unit that adds the shaping mode to shaping data for shaping the three-dimensional shaped object or adds a cleaning command corresponding to the shaping mode to the shaping data, and supplies the shaping data to a three-dimensional shaping device that controls cleaning of a nozzle in accordance with the shaping mode.

What is claimed is:

1. A method for manufacturing a three-dimensional shaped object comprising:
a first step of receiving designation of a shaping mode of a three-dimensional shaped object;
a second step of shaping, based on shaping data for shaping the three-dimensional shaped object, the three-dimensional shaped object by discharging a shaping material from a nozzle; and
a third step of controlling cleaning of the nozzle in accordance with the shaping mode received in the first step.

2. The method for manufacturing the three-dimensional shaped object according to claim 1, wherein
in the first step, the shaping mode is designated from a plurality of modes including a mode related to shaping precision of the three-dimensional shaped object and a mode related to a shaping time of the three-dimensional shaped object.

3. The method for manufacturing the three-dimensional shaped object according to claim 2, wherein
when a high-precision mode in which the three-dimensional shaped object is shaped with high precision or a low-speed mode in which the three-dimensional shaped object is shaped at a low speed is designated as the shaping mode, as compared with a case where a standard mode is designated as the shaping mode, at least one of the number of times of cleaning, a cleaning time, a cleaning strength, and a cleaning target nozzle is made different in the third step.

4. The method for manufacturing the three-dimensional shaped object according to claim 3, wherein
when the high-precision mode or the low-speed mode is designated as the shaping mode, as compared with the case where the standard mode is designated as the shaping mode, at least one of (1) increasing the number of times of cleaning, (2) lengthening the cleaning time, (3) increasing the cleaning strength, and (4) increasing the cleaning target nozzle is performed.

5. The method for manufacturing the three-dimensional shaped object according to claim 4, wherein
the (2) lengthening the cleaning time is implemented by increasing a time for discharging the shaping material from the nozzle or increasing the number of times of brushing the nozzle.

6. The method for manufacturing the three-dimensional shaped object according to claim 2, wherein
when a low-precision mode in which the three-dimensional shaped object is shaped with low precision or a high-speed mode in which the three-dimensional shaped object is shaped at a high speed is designated as the shaping mode, as compared with a case where a standard mode is designated as the shaping mode, the number of times of cleaning of a nozzle that discharges a support material in the third step is reduced.

7. The method for manufacturing the three-dimensional shaped object according to claim 1, wherein
a cleaning command is added to the shaping data in accordance with the shaping mode received in the first step, and in the third step, the cleaning is controlled in accordance with the cleaning command in the shaping data.

8. The method for manufacturing the three-dimensional shaped object according to claim 7, wherein
when a high-precision mode in which the three-dimensional shaped object is shaped with high precision or a low-speed mode in which the three-dimensional shaped object is shaped at a low speed is designated as the shaping mode, as compared with a case where a standard mode is designated as the shaping mode, the number of cleaning commands added to the shaping data is increased or a cleaning command having a stronger strength than that of a cleaning command added in the standard mode is added to the shaping data.

9. A three-dimensional shaping device comprising:
a shaping processing unit configured to shape, based on shaping data for shaping a three-dimensional shaped object, the three-dimensional shaped object by discharging a shaping material from a nozzle; and
a cleaning control unit configured to control cleaning of the nozzle in accordance with a designated shaping mode.
